(19) United States
(12) Patent Application Publication
(10) Pub. No.: US 2009/0110508 A1
(43) Pub. Date: Apr. 30, 2009

(54) Screw Band

(75) Inventor: Chao-Wei Lin, Tainan City (TW)

Correspondence Address: OSHA LIANG L.L.P., TWO HOUSTON CENTER, 909 FANNIN, SUITE 3500, HOUSTON, TX, 77010, US

(73) Assignee: Kwantex Research Inc., Tainan Hsien (TW)

(21) Appl. No.: 11/923,330

(22) Filed: Oct. 24, 2007

(51) Int. Cl. F16B 27/00

(52) U.S. Cl. 411/84

(57) ABSTRACT

A screw band includes a plurality of interconnected anchoring seats allowing screws to extend respectively therethrough. Each of the anchoring seats includes a seat body having an inner hole formed therethrough, and a plurality of equidistant slots extending outwardly from the inner hole to define a plurality of clamping arms for clamping the corresponding screw thereamong. The clamping arms of each of the anchoring seats are formed pressing toward each other to define a screw clamping space thereamong. Each of the slots has a through slot portion extending outwardly from the corresponding inner hole and formed through the corresponding seat body, and a blind slot portion extending outwardly from an outer end of the through slot portion to allow the corresponding anchoring seat to be broken therealong when the corresponding screw is passed through the corresponding screw clamping space.

### BACKGROUND OF THE INVENTION

1. Field of the Invention

This invention relates to a screw band for holding a plurality of screws thereon, and more particularly to a screw band allowing a specific electrical tool to drive the screws held thereon consecutively.

2. Description of the Related Art

Referring to FIG. 1, a first conventional screw band 1 disclosed in U.S. Pat. No. 5,522,687 includes a band body 11 formed with a row of equidistant screw holes 12, and a plurality of sleeves 13 extending respectively from walls of the band body 11 defining respectively the screw holes 12. Each of the sleeves 13 has an annular wall 130 and four triangular notches 131. Screws (not shown) are passed respectively and downwardly through the screw holes 12, and are respectively clamped within the sleeves 13. When the screws are driven by an electrical tool (not shown) to pass respectively and consecutively through the sleeves 13, due to the presence of the triangular notches 131, the sleeves 13 can expand. The expansible degree of the sleeves 13, however, is limited, thereby increasing the resistance against removal of the screws from the sleeves 13. Such an increased resistance results in a substantial amount of plastic scrapes being created from inner surfaces of the sleeves 13 due to contact with the screws when the screws are driven to rotate within the sleeves 13, respectively.

Referring to FIG. 2, a second conventional screw band 2 includes a band body 21, a plurality of screw holes 22, and a plurality of sleeve units 23 extending from the band body 21 and disposed respectively under the screw holes 22. Each of the sleeve units 23 has an annular wall 230 with three slots 231 formed therethrough to define three resilient clamping arms 233. Due to the formation of the slots 231 in the sleeves 23, when the screws are driven by the electrical tool to pass through the sleeves 23, respectively, the sleeves 23 can expand sufficiently to allow for smooth passage of the screws to thereby minimize the amount of plastic scrapes created from the sleeves 23 when the screws are driven to pass through the sleeves 23, respectively. In such a configuration, however, the screws cannot be clamped respectively within the sleeves 23 in a secure manner.

### SUMMARY OF THE INVENTION

The object of this invention is to provide a screw band that allows for smooth passage of screws therethrough and that can firmly clamp the screws thereon.

According to this invention, a screw band includes a plurality of interconnected anchoring seats adapted to allow screws to extend respectively therethrough. Each of the anchoring seats includes a seat body having an inner hole formed therethrough, and a plurality of equidistant slots extending outwardly from the inner hole to define a plurality of clamping arms for clamping the corresponding screw thereamong. The clamping arms of each of the anchoring seats are formed pressing toward each other to define a screw clamping space thereamong. Each of the slots has a through slot portion extending from the corresponding inner hole and formed through the corresponding seat body, and a blind slot portion extending outwardly from an outer end of the through slot portion so as to allow the corresponding anchoring seat to be broken therealong when the corresponding screw is passed through the corresponding screw clamping space.

Since each of the through slot portions extends from the corresponding inner hole, and is formed through the corresponding seat body, the screws can pass smoothly through the anchoring seats, respectively.

Furthermore, since each of the blind slot portions is not formed through the corresponding seat body, and is spaced apart from the corresponding inner hole, the screws can be clamped firmly on the anchoring seats, respectively.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a first conventional screw band disclosed in U.S. Pat. No. 5,522,687;

FIG. 2 is a perspective view of a second conventional screw band;

FIG. 3 is a fragmentary perspective view of the first preferred embodiment of a screw band according to this invention;

FIG. 4 is a sectional side view of an anchoring seat of the first preferred embodiment;

FIG. 5 is a top view of the anchoring seat of the first preferred embodiment;

FIG. 6 is a schematic view illustrating lower ends of a plurality of clamping arms of the anchoring seat of the first preferred embodiment in a state pushed by a screw to move away from each other;

FIG. 6a is a schematic view illustrating a modified screw-clamping space;

FIG. 7 is a top view of the anchoring seat of the first preferred embodiment, illustrating expansion of an inner hole as a result of movement of the screw thereinto;

FIGS. 7a and 7b are top views illustrating two modified assemblies of slots;

FIG. 8 is a sectional side view of the anchoring seat of the first preferred embodiment, illustrating how the anchoring seat is broken along blind slot portions of the slots to thereby remove each adjacent pair of the clamping arms from each other;

FIG. 9 is a top view of the anchoring seat of the first preferred embodiment, illustrating deformation of the inner hole as a result of movement of the screw into the anchoring seat;

FIGS. 10a, 10b, 10c, and 10d are fragmentary top views respectively of the second, third, fourth, and fifth preferred embodiments of a screw strip according to this invention, illustrating changes to the number of the clamping arms; and

FIGS. 11a, 11b, 11c, 11d, 11e, 11f, 11g, and 11h are fragmentary top views respectively of the sixth, seventh, eighth, ninth, tenth, eleventh, twelfth, and thirteenth preferred embodiments of a screw strip according to this invention, illustrating how a plurality of slots formed in an anchoring seat are tangent to an inner hole.

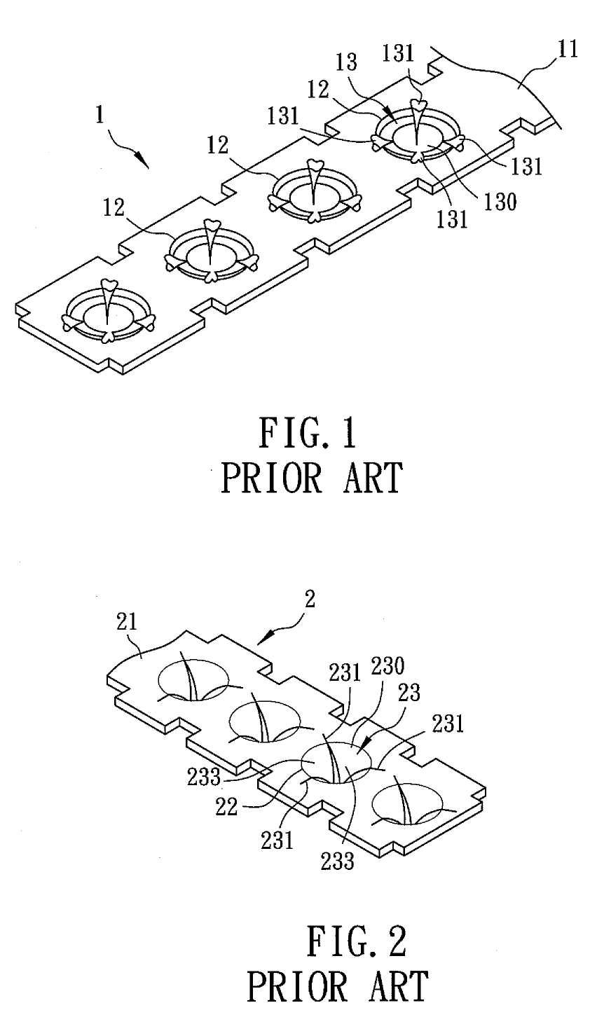

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

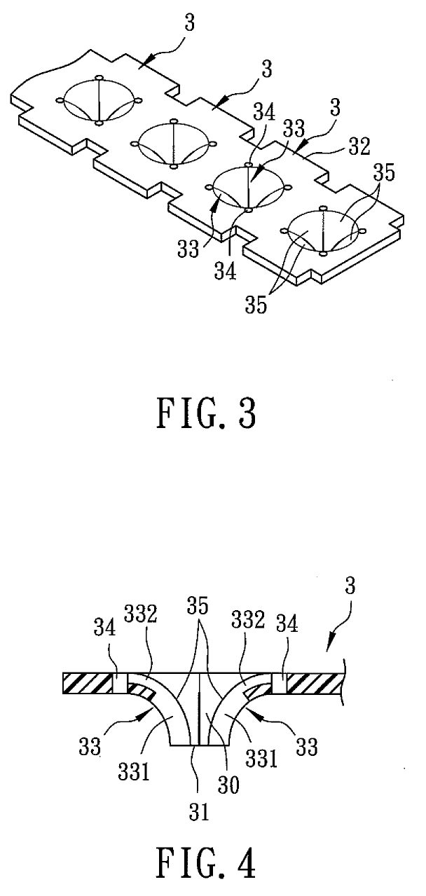

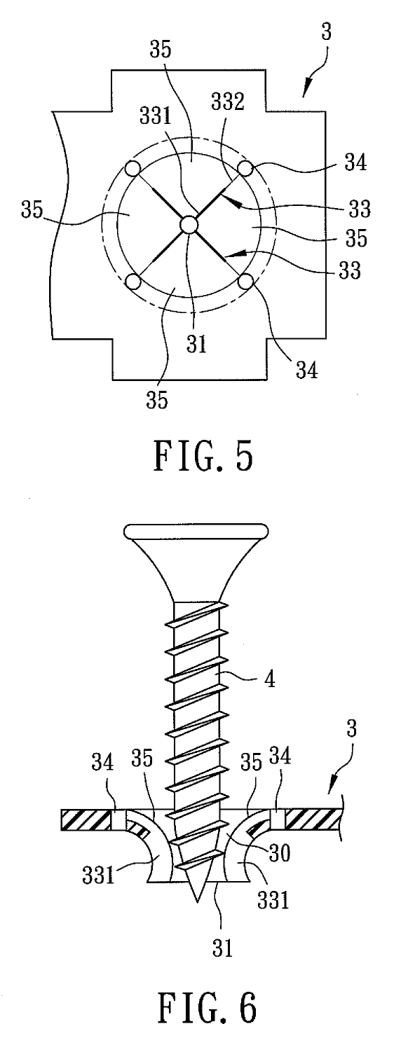

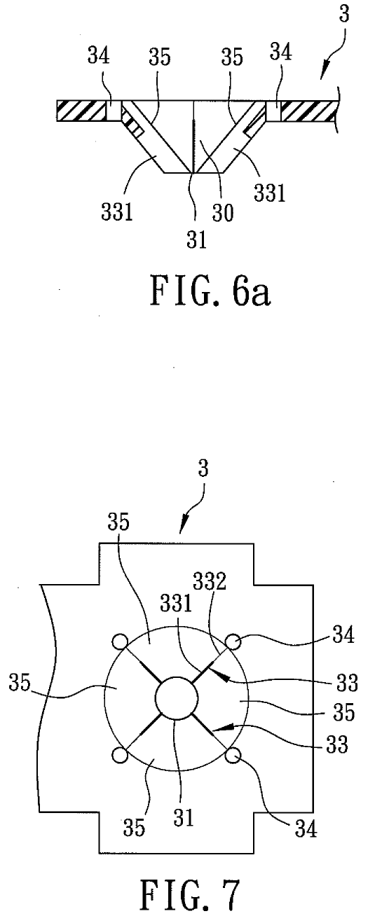

Referring to FIGS. 3, 4, and 5, the first preferred embodiment of a screw band is formed by extrusion using a plastic composite material comprised of a plastic material and paper pulp, and optionally sawdust, and is subsequently punched and pressed. The screw band allows a row of screws 4 (see FIG. 6) to extend therethrough, and includes a plurality of interconnected anchoring seats 3 for extension of the screws 4, respectively. The anchoring seats 3 are similar in construction. One of the anchoring seats 3 is described in the succeeding paragraphs.

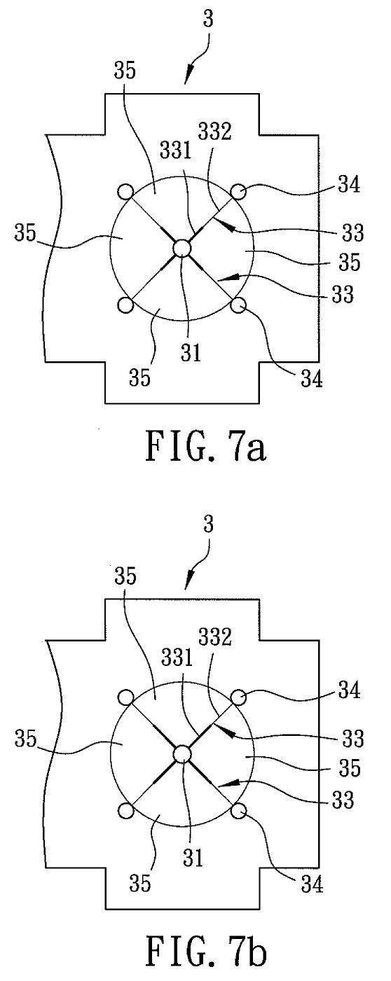

The anchoring seat 3 includes a rectangular seat body 32 having an inner hole 31 formed through a central portion thereof, four angularly equidistant slots 33 extending radially and outwardly from the inner hole 31, and four circular outer holes 34 in spatial communication with the slots 33, respectively. The slots 33 define four clamping arms 35 for clamping the screw 4 thereamong. The clamping arms 35 are formed pressing toward each other. Each of the slots 33 has a through slot portion 331 extending from the inner hole 31 and formed through the seat body 32, and a blind slot portion 332 extending outwardly from a radial outer end of the through slot portion 331. Each of the blind slot portions 332 has a depth smaller than the thickness of the seat body 32 (i.e., the blind slot portions 332 are not formed through the seat body 32), as shown in FIG. 4. Therefore, when the screw is driven by an electrical tool (not shown) to pass through a screw-clamping space 30 defined by the clamping arms 35, the anchoring seat 3 is broken along the blind slot portions 332. The outer holes 34 are in spatial communication with radial outer ends of the blind slot portions 332, respectively, are arranged along a circumferential direction of the inner hole 31, and each has a diameter greater than the width of each of the slots 33. In this embodiment, the through slot portions 331 are longer than the blind slot portions 332. Further, an assembly of the clamping arms 35 is in the form of a funnel such that the screw-clamping space 30 has a diameter that increases gradually in a direction away from the inner hole 31. The minimum diameter of the screw-clamping space 30 is smaller than the outer diameter of the screw 4. In alternative embodiments, the through slot portions 331 are shorter than the blind slot portions 332, as shown in FIG. 7a, or have a length equal to that of each of the blind slot portions 332, as shown in FIG. 7b.

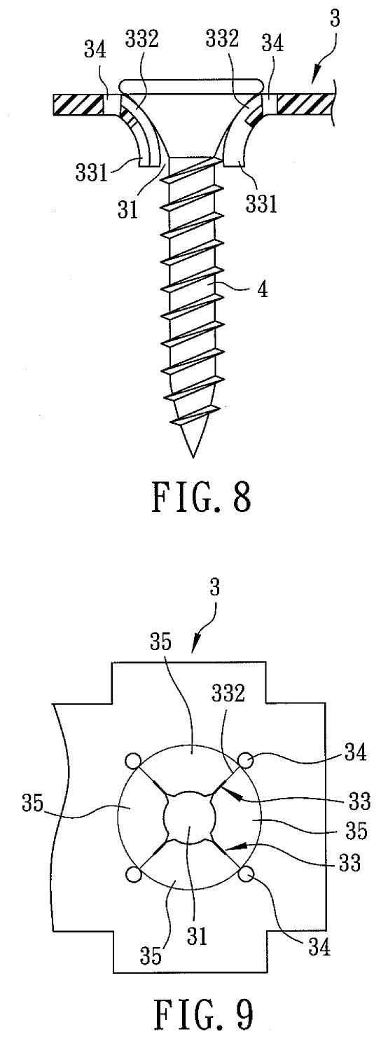

When the screw 4 is moved into the screw-clamping space 30, lower ends of the clamping arms 35 are pushed by a tip portion of the screw 4 to move away from each other to thereby allow the inner hole 31 to expand, as shown in FIGS. 6 and 7. In this state, because of the resilient restoration force of the clamping arms 35, the screw 4 can be clamped firmly within the screw-clamping space 30. When the screw 4 is driven by the electrical tool to move downwardly within the screw-clamping space 30, with particular reference to FIGS. 8 and 9, the anchoring seat 3 is broken along the blind slot portions 332 to further expand the inner hole 31, thereby facilitating smooth passage of the screw 4 through the screw-clamping space 30.

When the anchoring seat 3 is broken at the radial outer ends of the blind slot portions 332, due to the presence of the outer holes 34, the clamping arms 35 are further moved away from each other to ensure that the screw 4 can pass smoothly through the screw-clamping space 30.

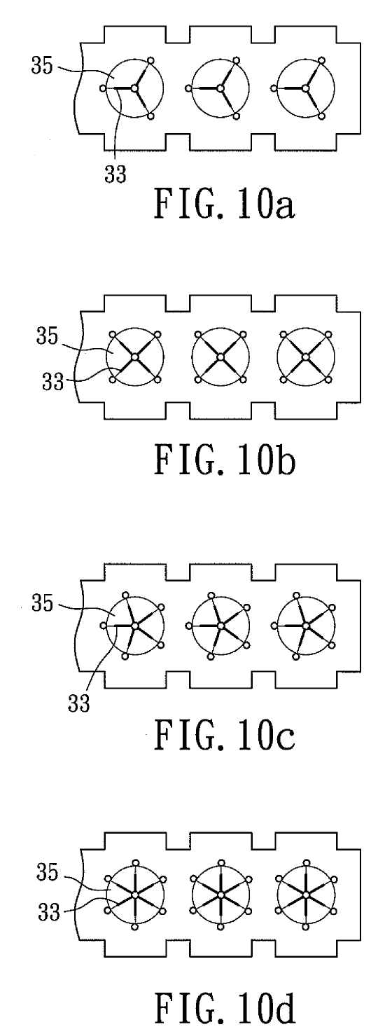

The number of the clamping arms 35 may be changed, as shown in FIGS. 10a, 10b, 10c, and 10d.

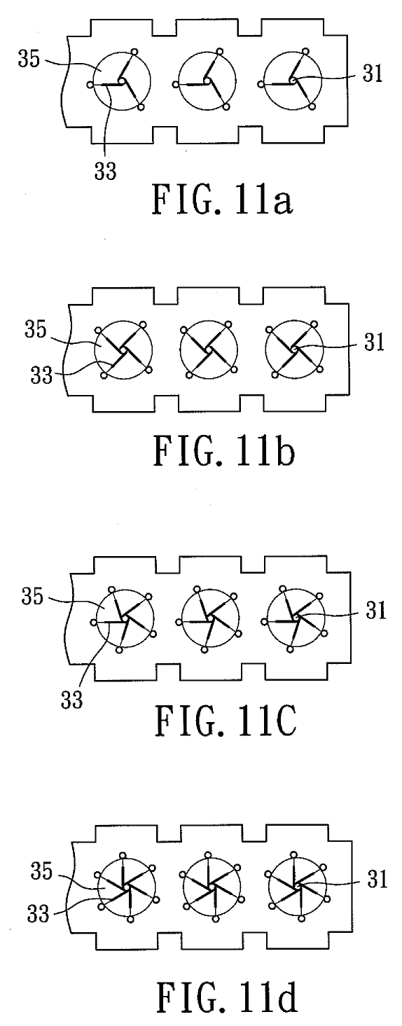

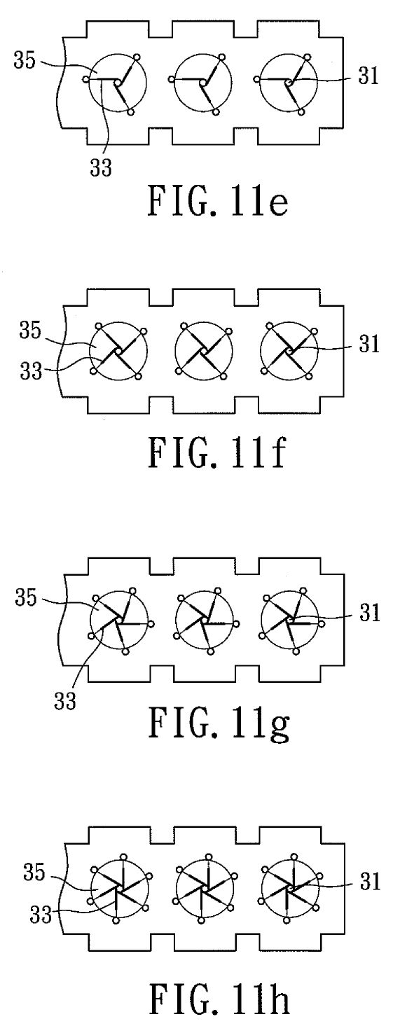

Alternatively, each of the slots 33 extends in a direction tangent to the corresponding inner hole 31, as shown in FIGS. 11a, 11b, 11c, and 11d, or in FIGS. 11e, 11f, 11g, and 11h. In addition, the screw-clamping space 30 may be frustoconical, as shown in FIG. 6a.

With this invention thus explained, it is apparent that numerous modifications and variations can be made without departing from the scope and spirit of this invention. It is therefore intended that this invention be limited only as indicated by the appended claims.

I claim:

1. A screw band adapted to allow a row of screws to extend therethrough, said screw band comprising a plurality of interconnected anchoring seats adapted to allow said screws to extend respectively therethrough, each of said anchoring seats includes:
a seat body having a thickness and an inner hole formed therethrough; and
a plurality of equidistant slots extending outwardly from said inner hole to define a plurality of clamping arms, said clamping arms being adapted to clamp a corresponding one of the screws thereamong, said clamping arms being formed pressing toward each other to define a screw-clamping space thereamong, each of said slots having a through slot portion extending from said inner hole and formed through said seat body, and a blind slot portion extending outwardly from an outer end of said through slot portion and having a depth smaller than said thickness of said seat body so as to allow a corresponding one of said anchoring seats to be broken along said blind slot portions when the corresponding one of the screws is passed through said screw-clamping space.

2. The screw band as claimed in claim 1, wherein each of said seat bodies further has a plurality of outer holes in spatial communication with outer ends of said blind slot portions, respectively, said slots having a width, said outer holes being arranged along a circumferential direction of said inner hole and having a diameter greater than said width of said slots.

3. The screw band as claimed in claim 2, wherein said through slot portions are longer than said blind slot portions.

4. The screw band as claimed in claim 2, wherein said through slot portions are shorter than said blind slot portions.

5. The screw band as claimed in claim 2, wherein said through slot portions have a length equal to that of each of said blind slot portions.

6. The screw band as claimed in claim 1, wherein said screw-clamping space has a diameter that increases gradually in a direction away from said inner hole, an assembly of said clamping arms being in the form of a funnel.

7. The screw band as claimed in claim 2, wherein said screw-clamping space is frustoconical.

8. The screw band as claimed in claim 1, wherein each of said slots extends in a radial direction of said inner hole.

9. The screw band as claimed in claim 1, wherein each of said slots extends in a direction tangent to said inner hole.
